(19) United States
(12) Patent Application Publication
(10) Pub. No.: US 2011/0047181 A1
(43) Pub. Date: Feb. 24, 2011

(54) METHOD AND SYSTEM FOR IDENTIFYING COMMONALITY AMONG PATTERN DEFINITIONS

(76) Inventors: James R. Malnati, Stillwater, MN (US); Donald J. Ethen, New Brighton, MN (US)

Correspondence Address: UNISYS CORPORATION;Office of the General Counsel, 801 Lakeview Drive, Suite 100, MailStop: 2NW, BLUE BELL, PA, 19422, US

(21) Appl. No.: 12/543,098

(22) Filed: Aug. 18, 2009

(51) Int. Cl. G06F 17/30

(52) U.S. Cl. 707/780; 707/E17.069

(57) ABSTRACT

A method and system for identifying commonality among pattern definitions among multiple database storage systems. The method creates pattern definition files for all pattern definitions stored in multiple databases. The name of a pattern definition file includes a group name, a pattern number, and a database associated with the pattern definition. A set of pattern definition files with same group name and pattern number are compared with each other to classify the set into exactly matching or partially matching.

### TECHNICAL FIELD

The present disclosure relates to automation systems, and more particularly to an inspection process employed for identifying commonality among code across multiple databases.

### BACKGROUND

Large-scale computer systems typically incorporate numerous components supplied by disparate manufacturers. Operators at central points in the systems exercise control, generally by receiving system messages and entering system commands. Because the operator often works though a system console, the system messages are referred to as “console messages.” These components usually require unique, often cryptic, commands, and an operator faces considerable difficulty in dealing with the entirety of commands required to control a complex system.

Autoaction Message Systems (AMS), such as Single Point AMS and CLEARPATH AMS, automate complex system operations by embedding required commands in callable pattern files. Each pattern file, stored in an autoaction database, includes message-matching criteria, coupled with and actions to be automatically executed upon matching a system message. Message-matching criteria identify the important parts of a message as well as constraints, such as message length, that must be satisfied for a pattern match. AMS recognizes a system message by comparing it to the pattern definitions in the active autoaction database, and upon determining a match, automatically executes actions defined in the matched pattern.

Pattern files include pattern definitions that characterize the content and context of console messages (the configuration part), and specify the actions to be performed in the event of message match (the action part). AMS uses delimiters (default or user-specified) to separate a message into portions called tokens and to compare the message tokens with the pattern tokens defined in the autoaction database. The “configuration” part provides a pattern identity in a specific “message group” and “message number”, specifies a target message, and identifies which of the message tokens must be the same to produce a match. Other portions of the configuration part may specify a time of day requirement, a variable value required, or other specifications using a CONSTRAINT command. A “match” occurs when the configuration part conditions are met, including the portions of the message defined in a TOKEN command, the number of tokens, the specifications of the CONSTRAINT command, and any other conditions. The pattern definitions can include several other commands such as PRIORITY, TYPE, DELIMITERS, and so on, which are commonly known in relation to AMS.

Conventionally, AMS databases include multiple pattern definitions and developers, in general, copy-paste pattern definitions across databases as and when required. In certain situations, however, a pattern definition may be copied in other databases with minor modifications. Further, the process of copy-pasting, with or without modification, results in multiple pattern definitions with the same group name across databases. Inevitably, typographical and other errors creep into the pattern definitions in the course of configuring pattern files.

With the proliferation of programming code, AMS databases become very large, and errors in database content become difficult to identify. AMS database auditors and administrators involved in database analysis and maintenance are expected to confirm appropriate operation of pattern definitions without having seen any code beforehand. Typically, auditors and administrators spend days in manual inspection of databases to detect pattern definitions with same group name but inconsistent code across varied databases, identifying areas of improvement. The manual inspection is time consuming and usually error prone.

It would be highly desirable to have an automated process that verifies consistent behavior of a console message across multiple database storage systems. Such a solution would allow auditors to skip the manual inspection step to identify commonality among code, ensuring maximum productivity.

### SUMMARY

According to aspects illustrated herein, there is provided a method for identifying commonality among pattern definitions across multiple database storage systems. The method includes creating pattern definition files for all pattern definitions stored in the multiple database storage systems. The filename for a pattern definition file includes a group name associated with the pattern definition, a pattern number associated with the pattern definition, and a database or system name indicating where the pattern definition is stored. Next, the method identifies a set of pattern definition files, from the total number of pattern definition files, with same group name and pattern number. Finally, the method includes comparing the content of each pattern definition file with other pattern definition files within the identified set of pattern definition files for classifying the set of pattern definition files into exactly matching, or partially matching.

Another embodiment of the present disclosure describes a system for identifying commonality among pattern definitions. The system includes a database storage system including at least one pattern definition. The system also includes a data processing system, which is operatively coupled to the database storage system, and includes a pattern processing module, an identification module, and a comparison module. The pattern processing module is configured to create pattern definition files for a multitude of pattern definitions stored in multiple database storage systems. The filename for a pattern definition file includes a group name associated with the pattern definition, a pattern number associated with the pattern definition, and a database or system name indicating where the pattern definition is stored. The identification module is configured to identify a set of pattern definition files from the total number of pattern definition files with same group name and pattern number. Further, the system employs the comparison module for comparing the content of each pattern definition file with other pattern definition files, within the identified set of pattern definition files, to classify the set into exactly matching or partially matching.

### BRIEF DESCRIPTION OF THE DRAWINGS

FIG. 1 illustrates an exemplary embodiment of a system for managing data on a database storage system.

FIG. 2 is a flowchart outlining a method for identifying commonality among pattern definition across multiple database storage systems.

FIG. 3 illustrates an exemplary list of pattern definition files with same group name and pattern number.

FIG. 4 illustrates an embodiment of a system for identifying commonality among pattern definitions across multiple database storage systems.

### DETAILED DESCRIPTION

The following detailed description is made with reference to the figures. Preferred embodiments are described to illustrate the claimed invention, not to limit its scope, which is defined by the claims. Those of ordinary skill in the art will recognize a variety of equivalent variations on the description that follows.

Generally speaking, a method and system for implementing maintenance of a database storage system is described below in connection with various embodiments of the disclosure. The database maintenance mechanism allows automatic identification of commonality among source code among multiple database storage systems. The disclosure compares code having the same identifier across multiple database storage systems and provides results in the form of a report. The automation process not only reduces the time spent by a database auditor or administrator in manually inspecting the source code to identify the commonality among the code, but it also helps in maintainability of the source code.

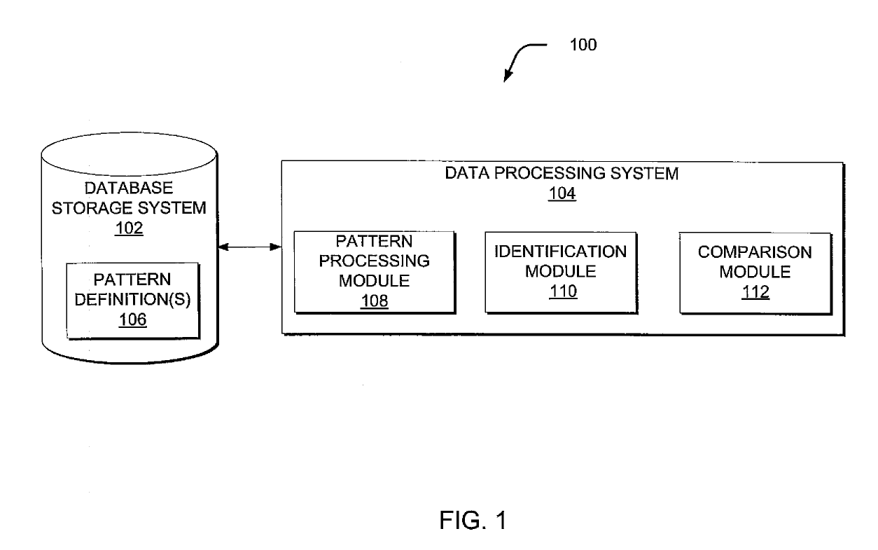

FIG. 1 illustrates an exemplary system 100 for managing data on database storage systems. The system 100 includes a database storage system 102 and a data processing system 104. The database storage system 102 can include any known database storage system known in the art.

Typically, a database storage system includes a number of pattern definitions. For example, the database storage system 102 includes pattern definition(s) 106. It should be understood that a single database storage system 102 is shown for purposes of simplicity, but those skilled in the art will appreciate that a real-world system would include a number of database storage systems tied together as is known in the art. It will be understood that the term “database,” in the present context, denotes any type of persistent storage, such as, for example, a relational database, a hierarchical database, an object oriented database, or a file system.

Each database storage system, such as the database storage system 102, is operatively coupled to the data processing system 104, which includes a pattern processing module 108, an identification module 110, and a comparison module 112.

The pattern processing module 108 creates pattern definition files for each pattern definition stored across multiple database storage systems. For example, the pattern processing module 108 creates a pattern definition file for the pattern definition 106. The filename for the pattern definition file uniquely identifies the pattern definition 106. It also includes the group name and the pattern number associated with the pattern definition 106, as well as the name of the database which stores the pattern definition 106.

The identification module 110 identifies a set of pattern definition files. The identified set is a subset of the total set of pattern definition files, and files in this set have the same group name and pattern number.

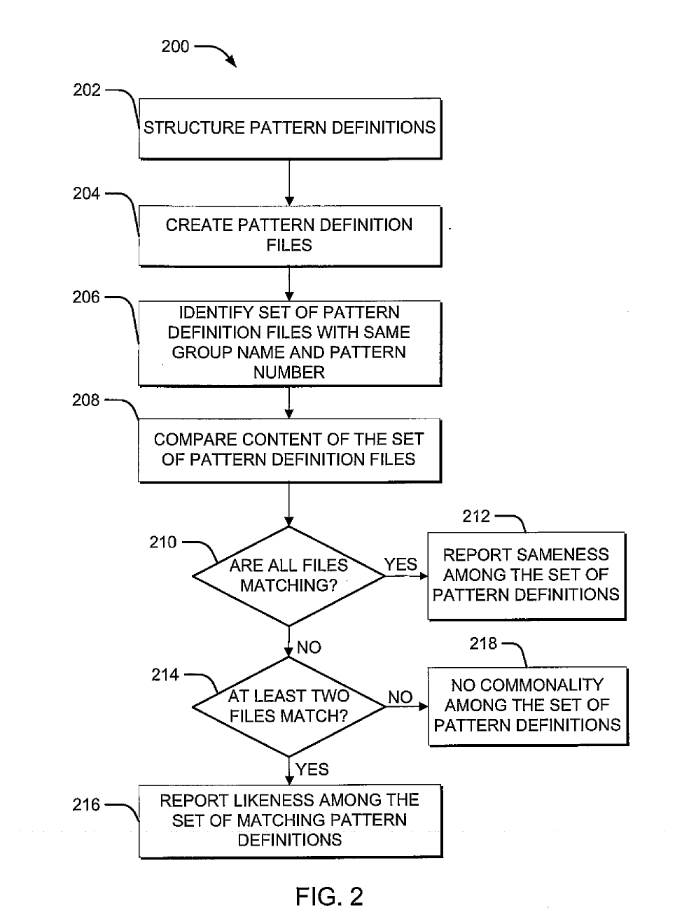

Once a set of pattern definition files has been identified, the comparison module 112 exhaustively compares the content of this set of pattern definition files and classifies the set into exactly matching or partially matching. The process of recognizing exactly matching or partially matching pattern definitions is discussed in detail below in connection with FIG. 2.

The system 100 provides a report of exactly matching pattern definitions across all database storage systems and pattern definitions matching in some of the database storage systems. In an embodiment of the disclosure, the system 100 generates a text document reporting exactly matching or partially pattern definitions.

FIG. 2 illustrates a flowchart of a method 200 for identifying commonality among pattern definitions stored across multiple database storage systems. The system 100 shown in FIG. 1 can act as an environment to implement the method 200; for purposes of clarity, however, the method 200 is set out in conjunction with Autoaction Message System (AMS). The method 200 describes a computer-operable script to perform an automated identification process in AMS databases. In one embodiment of the disclosure, the script includes UNIX shell scripts.

The AMS database contains a series of pattern definitions. Each pattern definition includes message matching criteria for matching messages from managed systems, together with actions to be automatically executed when a system message matches a pattern definition. A system may possess any number of AMS databases, but only one database at a time can actively match messages for a system.

At step 202, the method 200 includes structuring pattern definitions stored in multiple database storage systems into a specified format. The method 200 begins by collecting compiled database files for all AMS databases and formatting the pattern definitions. The specified format refers to the formatted and structured output of the Dump AMS Database (DADB) utility, which converts the compiled, run-time version of an autoaction database into its source-file (text) format. Formatting results in a consistent and predictable layout of the databases, and the source pattern and variable definitions, ideally suited for programmatic scanning.

At step 204, the method 200 creates pattern definition files for all the pattern definitions stored in multiple AMS databases. The filename for a pattern definition file uniquely identifies a pattern definition. One embodiment of the method 200 generates a filename by hashing a group name, which is a pattern number associated with the pattern definition. Further, the filename also includes the database name that stores the pattern definition. In several cases, the group name of the pattern definition includes a forward slash “/”, and the filename for the pattern definition file created for such a pattern definition will replace the forward slash with an underscore. Thus, the filename for a pattern definition file can be expressed as “GROUP_NAME.PATTERN_NUMBER.DATABASE/SYSTEM”.

An exemplary pattern definition stored in BA2 database storage system is provided below:

DEFINE “ABORT/ERROR” 1

| MESSAGE | “ADVnnn xxxxx FIN” |
|---|---|
| /* | --1---*--2--*-3- */ |
| TYPE PRIVILEGED-EXEC OTHER | |
| INSTANCE | PRIMARY |
| PRIORITY | 129 |

TOKEN KEYWORD 3 “FIN”
TOKEN MASKED 1 “ADV\*3\”
ACTION ALL HOLD
ACTION ALL ALARM “0”

END

The pattern definition file created for the exemplary pattern definition will uniquely identify this pattern definition. The filename for this pattern definition file is ABORT_ERROR.00001.BA2.

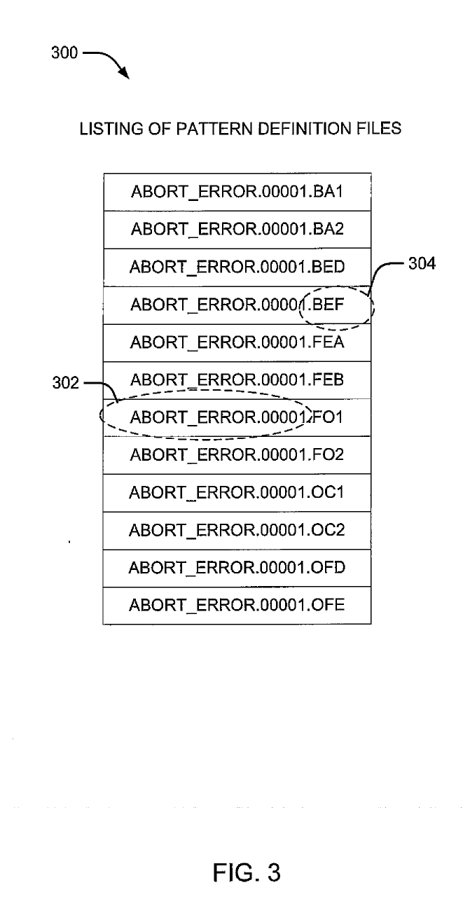

At step 206, a set of pattern definition files, from the total number of pattern definition files created at step 204, with same group name and pattern number is identified. An identified list of pattern definition files is shown in the following sections in connection with FIG. 3.

At step 208, the method 200 compares the content of the identified set of pattern definition files. The number of comparisons to be performed is calculated using combinations of the identified set of files. For example, if n indicates the number of database storage systems that store the identified set of pattern definition files, the total number of comparisons is expressed by ₙCₖ. The number of files compared at a time is shown by the constant k, which here will be two files at a time, so that k=2.

Step 210 determines whether all pattern definition files within the identified set are identical. If the content of all the pattern definition files within the identified set of pattern definition files do match, then step 212 reports the set of pattern definition files as exactly matching. The exactly matching set of pattern definition files is stored in a file referred to as a “sameness” file. As the name suggests, the “sameness” file indicates the pattern definitions that are exactly same in all the AMS databases. In an embodiment of the disclosure, the “sameness” file is named as “FILEsames”. An exemplary “FILEsames” file is set out below:

FILEsames.doc

Start of sames:

HARDWARE.00002 same in all files!
_Acquire.00002 same in all files!
_Acquire.00003 same in all files!
_Acquire.00004 same in all files!
_Keyins.00001 same in all files!
_Keyins.00002 same in all files!
_Keyins.00003 same in all files!
_Keyins.00004 same in all files!
_Keyins.00005 same in all files!
_Keyins.00006 same in all files!

If the content of all the pattern definition files within the set does not match, step 214 determines whether at least two pattern definition files do match. The set including at least two matching pattern definition files is reported as a partially matching set at step 216. The partially matching set is stored in a file referred to as a “likeness” file, which includes the matching pattern definitions within the identified set of pattern definition files. In an embodiment of the disclosure, the “likeness” file is stored as “FILElikes”. An exemplary “FILElikes” file is set out below:

ABORT_ERROR.00001---------------

BA2 same as FEA
BA2 same as FEB
BED same as OTE
FEA same as FEB
FO1 same as FO2
FO1 same as OC1
FO2 same as OC1
OC2 same as OFD
OC2 same as OIE
OFD same as OIE

The “likeness” file provides considerable information about pattern definitions matching in at least two but less than the total number of the database storage systems. In the example provided above, the “likeness” file indicates that the pattern definitions, with the group name “ABORT_ERROR” and pattern number 1, are identical in AMS databases BA2 and FEA, BA2 and FEB, and so on.

If no pattern definition files match, the step 218 reports no commonality among the set of pattern definition having the same group name and pattern number. For example, if a pattern definition is included in only one database storage system, the method 200 identifies and reports such pattern definition as well. Such a report is included in the “likeness” file; however, those skilled in the art will appreciate that no commonality report can also be reported in a separate file. An exemplary report is set out below:

ABORT.00001---------------
One system only using this pattern: ABORT.00001.OFE

The method 200 repeats steps 206 to 218 for every set of pattern definition files with common group name and pattern number.

The method 200 generates results in the form of a report, such as the “sameness” file and the “likeness” file, which reduces the time spent in manual inspection of the code for maintenance. The “sameness” file lists pattern definitions with consistent code in all database storage systems. By establishing the similarity in code of a pattern definition across all database storage systems, an auditor can confirm consistent behavior of the pattern definition in all the database storage systems which deploy that pattern definition. On the contrary, the “likeness” file lists pattern definitions with matching code in some of the database storage systems. The significance of this report is that it allows an administrator to identify pattern definitions existing in substantial number of databases with different codes. The administrator can use this information to modify such pattern definitions, resulting in a uniform pattern definition code in all the databases, which in turn improves maintainability.

FIG. 3 illustrates an exemplary listing of pattern definition files 300 with the same group name and pattern number. The pattern definition files 300 is an exemplary listing of files as identified at step 206 (FIG. 1). Each pattern definition file name includes a pattern identifier 302 and a database name 304. The pattern identifier 302 specifies the group name and pattern number associated with a pattern definition, and the database name 304 indicates the database that stores the pattern definition. As explained in connection with step 208 (FIG. 2), the content of the pattern definition files 300 are compared to determine whether the list exactly matches or partially matches.

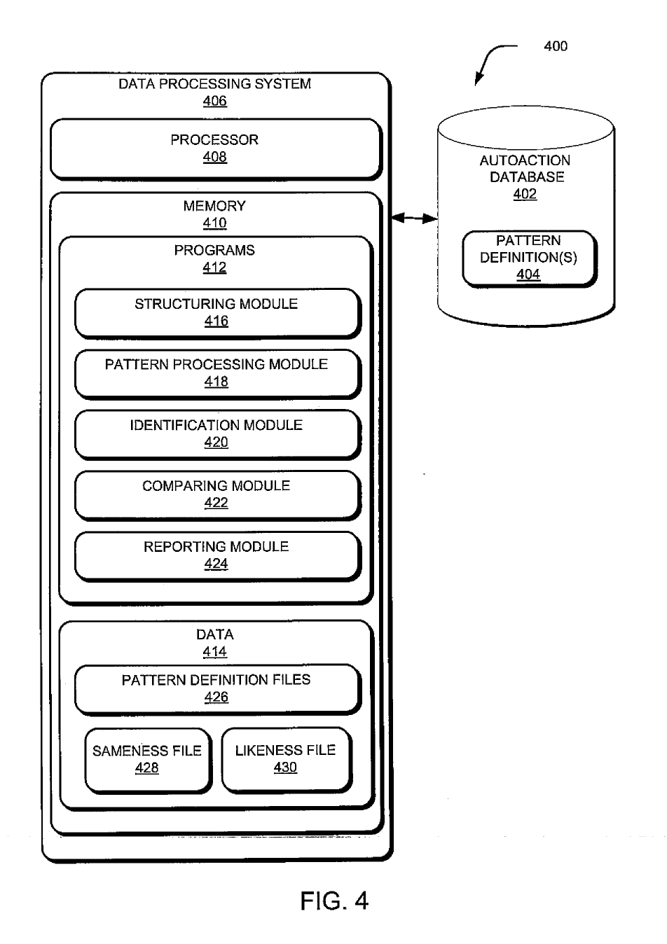

FIG. 4 illustrates an embodiment of a system 400, for identifying commonality among pattern definitions stored across multiple database storage systems, discussed in relation to an AMS. The system 400 provides a suitable environment to implement the method 200 discussed in connection with FIG. 2. Various other embodiments, however, can be anticipated to address many different systems or applications in which a large amount of pattern definitions needs to be analyzed and reported in an organized way.

The system 400 includes an autoaction database 402, which includes pattern definition(s) 404, operatively coupled to a data processing system 406. Each autoaction database, such as the autoaction database 402, includes at least one pattern definition. For simplicity, FIG. 4 depicts a single autoaction database; however, those skilled in the art will appreciate that the data processing system 406 may be coupled to a number of autoaction databases, which in turn will include multiple pattern definitions. For reasons of clarity, these autoaction databases are referred to as the autoaction databases 402 and pattern definitions included in autoaction databases 402 are collectively referred to as the pattern definitions 404. A typical AMS will include a large number of pattern definitions, running into the thousands in some systems

The data processing system 406 further includes a processor 408 coupled to memory 410. The processor 408 can include one or more microprocessors, microcomputers, microcontrollers, digital signal processors, central processing units, state machines, logic circuitries, or other devices known in the art. The processor 408 fetches and executes computer-readable instructions stored in the memory 410.

The memory 410 can include any computer-readable medium known in the art including, for example, volatile memory such as a random access memory, or non-volatile memory such as flash memory. As shown, the memory 410 further consists of programs 412 and data 414. The programs 412 include computer-implemented code, which comprises modules such as a structuring module 416, a pattern processing module 418, an identification module 420, a comparing module 422, and a reporting module 424 for identifying commonality among pattern definitions 404. Those skilled in the art will appreciate that the memory 410 can include several other modules that supplement applications on any computing based device such as process receiving applications and similar systems operating on the data 414.

The structuring module 416 formats the pattern definitions 404 in a form suitable for automated processing, as discussed in connection with step 202 of FIG. 2. The pattern processing module 418 creates pattern definition files 426 for the pattern definitions 404. These pattern definition files 426, such as the pattern definition files 300 shown in connection with FIG. 3, are stored in the data 414. As discussed at step 204, the filename for a pattern definition file includes a group name, pattern number, and an autoaction database associated with the pattern definition. The pattern processing module 418 creates pattern definition files 426 for all pattern definitions 404 stored across multiple autoaction databases systems. FIG. 4 illustrates pattern definition files 426 stored in the data 414, but those skilled in the art will appreciate that pattern definition files 426 may be stored in the same database to which the pattern definition belongs, or in other memory locations.

The identification module 420 identifies a set of pattern definition files having the same group name and pattern number. The identified pattern definition files are compared by the comparison module 422, as shown at step 208. The comparison module 422 classifies the set of pattern definition files into exactly matching or partially matching sets, and subsequently the reporting module 424 outputs the results of the comparisons.

The set of exactly matching pattern definition files is reported in a “sameness” file 428, and the set of partially matching pattern definitions is reported in a “likeness” file 430 (discussed in connection with steps 210 to 216). The “sameness” file 428 and the “likeness” file 430 indicate commonality among pattern definitions 404.

The claimed invention results in identification of common pattern definitions across multiple database storage systems through an organized report, generated automatically, in a quick and efficient manner.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While this specification contains many specific implementation details of a method and system for managing data in a system for automating responses to system messages, these should not be construed as limitations on the scope of any invention or of what may be claimed, but rather as descriptions of features, that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination.

Similarly, the fact operations are depicted in the drawings in a particular order does not set a requirement that such operations be performed in the particular order shown, or in sequential order, or that all illustrated operations be performed, to achieve desirable results

It will be appreciated that various of the features and functions disclosed above, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1) A method for identifying commonality among pattern definitions, the method comprising:
creating a plurality of pattern definition files for a plurality of pattern definitions stored in multiple database storage systems, wherein the file name for a pattern definition file includes:
a group name associated with the pattern definition;
a pattern number associated with the pattern definition; and
a database name indicating where the pattern definition is stored;
identifying a set of pattern definition files from the plurality of pattern definition files with same group name and pattern number; and
comparing the content of each pattern definition file with other pattern definition files within the identified set of pattern definition files for classifying the set of pattern definition files into:
exactly matching; or
partially matching.

2) The method of claim 1 further comprising structuring the plurality of pattern definitions into a specified format.

3) The method of claim 2, wherein the structuring is performed before creating the plurality of pattern definition files.

4) The method of claim 1, wherein the database storage system includes an Autoaction Message System (AMS).

5) The method of claim 4 further comprising structuring the plurality of pattern definitions into a specified format using a Dump AMS database (DADB) utility.

6) The method of claim 1 further includes reporting the exactly matching set of pattern definition files in a sameness file.

7) The method of claim 6, wherein the sameness file includes exactly matching pattern definitions in all the database storage systems.

8) The method of claim 1 further includes reporting the partially matching set of pattern definition files in a likeness file.

9) The method of claim 8, wherein the likeness file includes pattern definitions matching in at least two database storage systems and less than the total number of database storage systems.

10) A system for identifying commonality among pattern definitions comprising:
a database storage system including at least one pattern definition; and
a data processing system operatively coupled to a plurality of database storage systems, the data processing system including:
a pattern processing module configured to create a plurality of pattern definition files for a plurality of pattern definitions stored in the plurality of database storage systems, wherein the name of a pattern definition file includes:
a group name associated with the pattern definition;
a pattern number associated with the pattern definition; and
a database name indicating where the pattern definition is stored;
an identification module for identifying a set of pattern definition files from the plurality of pattern definition files with same group name and pattern number; and
a comparison module for comparing the content of each pattern definition file with other pattern definition files within the identified set of pattern definition files to classify the set of pattern definition files into:
exactly matching; or
partially matching.

11) The system of claim 10, wherein the pattern processing module is further configured to structure the plurality of pattern definitions into a specified format.

12) The system of claim 10, wherein the database storage system includes an Autoaction Message System (AMS).

13) The method of claim 12, wherein the pattern processing module structures the plurality of pattern definitions into a specified format using a Dump AMS database (DADB) utility.

14) The system of claim 10 further including a reporting module for reporting:
the exactly matching pattern definitions in a sameness file; and
the partially matching pattern definitions in a likeness file.

15) The system of claim 14, wherein the sameness file includes pattern definitions exactly matching in all the database storage systems.

16) The system of claim 14, wherein the likeness file includes pattern definitions matching in at least two database storage systems and less than the total number of database storage systems.
